(19) United States
(12) Patent Application Publication
(10) Pub. No.: US 2014/0125066 A1
(43) Pub. Date: May 8, 2014

(54) MICRO GAS TURBINE

(71) Applicants: Thomas Baumgart, Usingen (DE); Elmar Lange, Gummersbach (DE)

(72) Inventors: Thomas Baumgart, Usingen (DE); Elmar Lange, Gummersbach (DE)

(73) Assignee: Matuschek Mestechnik GmbH, Alsdorf (DE)

(21) Appl. No.: 14/124,859

(22) PCT Filed: Jun. 6, 2012
(86) PCT No.: PCT/EP12/60746

§ 371 Date: Dec. 9, 2013

(30) Foreign Application Priority Data
Jun. 21, 2011 (DE) 102011051240.3

(51) Int. Cl. H02K 7/18; F02C 7/06

(52) U.S. Cl. CPC H02K 7/1823; F02C 7/06
USPC 290/1 A; 415/122.1

(57) ABSTRACT

A micro gas turbine has a compressor and a turbine, the rotors of which are arranged on a common driveshaft. The aim of the described system is to provide a lightweight and inexpensive micro gas turbine. This is achieved in that the driveshaft is mounted using at least two rolling bearings, one of which is arranged in the vicinity of the compressor rotor and one of which is arranged in the vicinity of the turbine rotor. The drive shaft is designed in a hollow manner, the inner hollow space of the driveshaft being filled with an evaporable coolant.

The invention relates to a micro gas turbine with a compressor and a turbine, the rotors of which are arranged on a common drive shaft.

Such micro gas turbines are known from printed publication WO 2005/046021 A2, for example. Here, it is proposed to support the rotor by means of an air-cushion bearing. Such an air-cushion bearing has proved to be successful for supporting the turbine shaft of a micro gas turbine because it can be operated free of lubricant with very little bearing friction and operates in a trouble-free manner even at high temperatures. Turbine shafts supported on an air cushion, however, are used in fairly large micro turbines with a power output of 30 kW or more. Air-cushion bearings are costly in production and therefore bring about a price increase of the micro gas turbines.

It is the object of the invention to create a lightweight and inexpensive micro gas turbine.

This object is achieved according to the invention by the drive shaft being supported by means of at least two anti-friction bearings, of which one is arranged in the vicinity of the compressor rotor and one in the vicinity of the turbine rotor, and by the drive shaft being of hollow design, wherein its internal cavity is filled with an evaporable cooling medium.

In other words, the shaft, which supports the compressor rotor and the turbine rotor of the micro gas turbine, is designed as a heat pipe. Inside the cavity of the tubular shaft is a cooling medium which is liquid in the temperature range of the cold end of the drive shaft and is gaseous in the temperature range of the hot end of the drive shaft. In this way, the liquid cooling medium is as a result of the heat energy which is fed in the high-temperature range of the drive shaft in the region of contact of the cooling medium with the inside wall of the hollow drive shaft in the vicinity of the turbine rotor. The evaporated cooling medium moves away from the inside wall of the drive shaft towards the middle of the drive shaft. Here, it can flow back into the low-temperature region of the drive shaft where it condenses again and releases heat energy in the process.

The internal cavity of the drive shaft is preferably of a conical design in the axial direction, wherein the smaller diameter lies in the vicinity of the compressor rotor and the larger diameter in the vicinity of the turbine rotor. The compressor rotor forms the cold end of the drive shaft at which the cooling medium condenses in said drive shaft. The cooling medium which is in contact with the inside wall of the drive shaft is made to rotate as a result of the rotation of the shaft. On account of the conical shape of the internal bore of the drive shaft, the rotating cooling medium is driven outward by centrifugal force and therefore towards the larger diameter in the vicinity of the turbine rotor. Here, the increased temperature, which evaporates the cooling medium, prevails.

The basic principle of a conical heat pipe for cooling an end of a rotating shaft is described in British printed patent application GB 1,361,047, for example. The present invention utilizes this cooling effect in order to use anti-friction bearings for the drive shaft of an efficient micro gas turbine, wherein the bearings in the vicinity of the turbine are cooled by means of the heat pipe in the interior of the drive shaft.

The wall of the internal cavity of the drive shaft can have radially inwardly projecting ribs at least in the region of the compressor rotor. The ribs bring about an improved acceleration of the heating medium in the direction of rotation and ensure that in the region of the compressor rotor the condensed heating medium rotates essentially at the rotational speed of the drive shaft. As a result of this, the transporting of the condensed cooling medium to the shaft end with the larger inside diameter, that is to say towards the turbine rotor, is ensured.

In the region of the ends of the heat pipe, use can be made of materials for producing the shaft, especially on its inner surface, which bring about a particularly good heat transfer between the inside wall of the heat pipe and the cooling medium. Furthermore, structures (projections or grooves) can be arranged on the surface facing the cavity of the heat pipe which improve the transfer of heat between cooling medium and surface. The cooling medium is usually water, wherein the internal pressure of the heat pipe is to be adapted to the operating temperatures in the region of the turbine bearing and of the compressor rotor.

In a preferred embodiment, the turbine rotor is of solid design and fastened on the end of the drive shaft. The solid design of the turbine rotor increases its rigidity and avoids the risk of damage at high rotational speeds and high temperatures of the turbine rotor. As a result of the turbine rotor being fastened on the shaft end, usually welded on, a lower quantity of heat enters the drive shaft in comparison to a rotor which is pushed onto the shaft. As a result of this, the quantity of heat which is to be transported away also decreases.

The compressor rotor on the other hand can have a bore through which the drive shaft extends. As a result of this, the size of the contact surface between compressor rotor and drive shaft is larger than the contact surface between turbine rotor and drive shaft. Consequently, the surface for discharging heat from the heat pipe is enlarged, as a result of which the cooling capacity of the heat pipe is improved.

Also arranged on the drive shaft can be the rotor of a generator, by means of which electric current is generated. In this case, the turbine rotor is preferably arranged on one side of the compressor rotor, whereas the generator rotor lies on the other, opposite side of the compressor rotor. In particular, the generator rotor can be provided with permanent magnets for electric current generation.

Also, in a preferred embodiment, flow passes radially through the compressor rotor and turbine rotor. A bearing shield, which supports the static part of the anti-friction bearing, can be arranged in each case between the anti-friction bearings and the adjacent rotor, that is to say the turbine rotor or the compressor rotor.

The micro gas turbine, according to the invention, preferably has a power rating of 30 kW or less. Such a micro gas turbine can be produced with a fairly low weight of less than 10 Kg, for example. Such a micro gas turbine, according to the invention, is preferably used in conjunction with a chargeable battery and at least one electric motor for operating a motor vehicle. The electric motor usually has in this case a maximum power output of more than 30 kW. As a result of this, the acceleration values which are customary for motor vehicles can be achieved. The average power output which is required for operating a motor vehicle, however, lies way below the maximum power output, especially below 30 kW, or, in the case of light private vehicles, even below 10 kW. Charging of the chargeable vehicle battery by means of a range extender, which according to the invention is driven by a micro gas turbine, is sufficient for continuous operation.

The invention is described below with reference to the attached drawings.

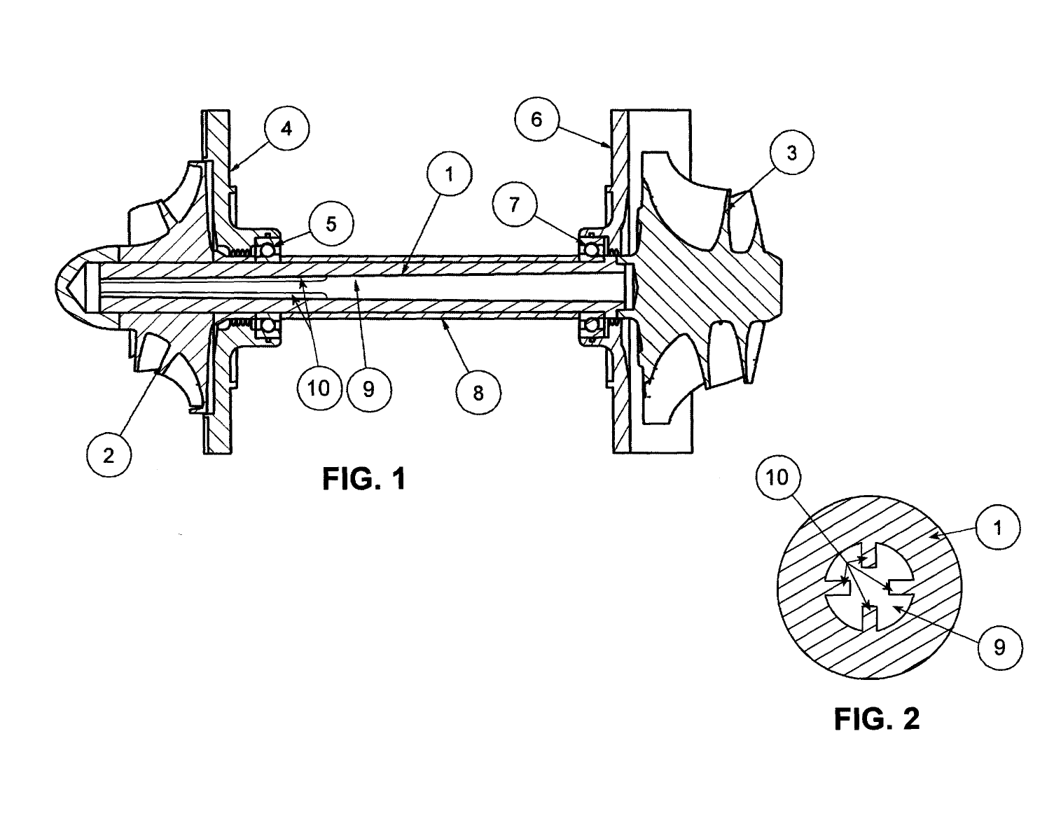

FIG. 1 shows a sectional view of the drive shaft and rotors of a micro gas turbine according to the invention.

FIG. 2 shows a cross-sectional view of the drive shaft.

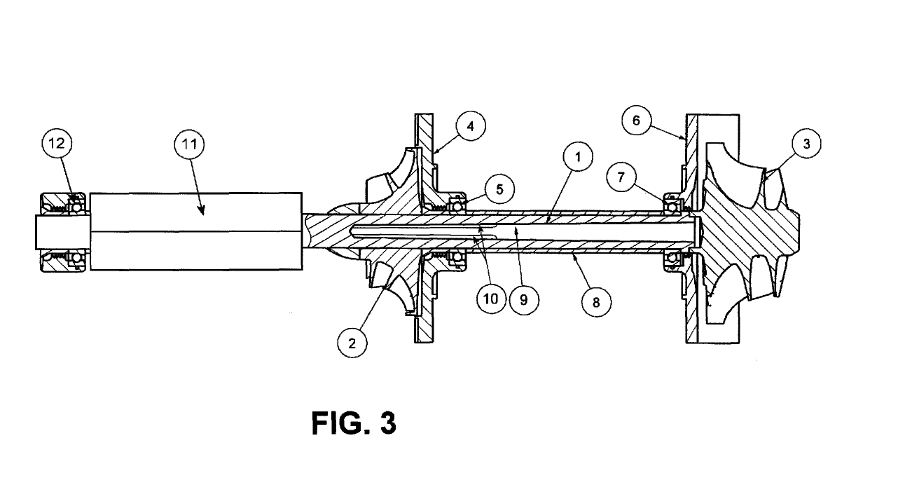

FIG. 3 shows a schematic view of the drive shaft of the micro gas turbine with the rotor of a generator located thereupon.

In FIG. 1, the movable components of a micro gas turbine according to the invention are to be seen. A compressor rotor 2 and a turbine rotor 3 are arranged on a common drive shaft 1. Flow passes radially through both compressor rotor 2 and turbine rotor 3.

The drive shaft 1 is supported via an anti-friction bearing 5 in the vicinity of the compressor and via an anti-friction bearing 7 in the vicinity of the turbine. The static bearing shells are arranged in each case in a bearing shield 4 or 6. For fixing the bearings on the drive shaft 1, a sleeve 8 is provided between the two bearings 5, 7.

It is to be seen that the drive shaft 1 is of hollow design. A conical bore extends through the drive shaft in the axial direction and forms a cavity 9 there. The smaller diameter of the conical cavity 9 extends through the entire shaft from the compressor rotor 2 to the turbine rotor 3. The largest diameter is located in the region of the turbine rotor 3. A cooling medium, preferably water, is located inside the cavity 9. The cavity 9 is tightly sealed off and has an internal pressure which is optimized for the operating temperature of compressor rotor 2 and turbine rotor 3. The cooling medium evaporates on the wall of the cavity 9 on account of the increased temperature and the heat which is fed through the turbine 3 to the turbine-side end of the drive shaft 1. As a result of the cooling medium evaporating, the turbine-side anti-friction bearing 7 is cooled. The increased evaporation pressure drives the evaporated cooling medium towards the other shaft end in the vicinity of the compressor rotor 2. A considerably cooler wall temperature prevails here so that the cooling medium in the region of the compressor rotor 2 condenses on the wall of the cavity 9. The inside wall of the cavity 9, as apparent from FIGS. 1 and 2, has radially inwardly projecting ribs 10. These entrain the condensed cooling medium and accelerate it in the direction of rotation to the rotational speed of the drive shaft 1. As a result of the conical design of the cavity 9 of the drive shaft 1, the condensed cooling medium is propelled along the inside wall of the cavity towards the large diameter in the vicinity of the turbine rotor 3.

Also to be seen in FIG. 1 is that the turbine rotor 3 is mounted on the end of the drive shaft 1 in an abutting manner. As a result of this, only a relatively small area is available for entry of heat from the turbine rotor into the drive shaft 1. This heat is transported away by the cooling medium inside the drive shaft 1 in order to avoid overheating of the turbine-side bearing 7.

The compressor rotor 2 is penetrated by the drive shaft 1. As apparent in FIG. 3, the rotor 11 of a generator can be connected to the compressor rotor 2. Since the drive shaft 1 has contact with the compressor rotor 2 along the entire bore in said compressor rotor 2, a very much larger surface for the passage of heat is made available here. The transporting away of the heat from the cavity 9 of the drive shaft is improved as a result of this larger surface. The rotor of the generator 11 lies on the side of the compressor rotor 2 which is opposite the turbine rotor 3. On the other side of the rotor of the generator 11, a further anti-friction bearing 12 is provided for supporting the drive shaft.

### LIST OF DESIGNATIONS

1 Drive shaft
2 Compressor rotor
3 Turbine rotor
4 Bearing shield
5 Anti-friction bearing
6 Bearing shield
7 Anti-friction bearing
8 Sleeve
9 Cavity
10 Rib
11 Rotor of a generator
12 Anti-friction bearing

1. A micro gas turbine, comprising:
a compressor and a turbine, a rotor of the compressor and a rotor of the turbine being arranged on a common drive shaft, wherein the drive shaft is supported using at least two anti-friction bearings, of which one is arranged in a vicinity of the compressor rotor and one is arranged in a vicinity of the turbine rotor, wherein the drive shaft is of hollow design, and wherein an internal cavity of the drive shaft is filled with an evaporable cooling medium.

2. The micro gas turbine as claimed in claim 1, wherein the internal cavity is of conical design in an axial direction of the drive shaft, and wherein a smaller diameter of the internal cavity lies in the vicinity of the compressor rotor and a larger diameter of the internal cavity lies in the vicinity of the turbine rotor.

3. The micro gas turbine as claimed in claim 1, wherein a wall of the internal cavity of the drive shaft has radially inwardly projecting ribs.

4. The micro gas turbine as claimed in claim 1, wherein the turbine rotor is of solid design and is fastened on an end of the drive shaft.

5. The micro gas turbine as claimed in claim 1, wherein the compressor rotor has a bore through which the drive shaft extends.

6. The micro gas turbine as claimed in claim 5, wherein a rotor of a generator is arranged on the drive shaft.

7. The micro gas turbine as claimed in claim 6, wherein the turbine rotor lies on one side of the compressor rotor and the rotor of the generator lies on the other side of the compressor rotor.

8. The micro gas turbine as claimed in claim 1, wherein flow passes radially through at least one of: the compressor rotor or the turbine rotor.

9. The micro gas turbine as claimed in claim 1, further comprising:
a bearing shield arranged between the anti-friction bearings and at least one of: the turbine rotor or the compressor rotor.

10. The micro gas turbine as claimed in claim 1, wherein the micro gas turbine has rated power of 30 kW or less.

11. A motor vehicle, comprising:
at least one chargeable battery; and
at least one electric motor including a micro gas turbine which drives a generator for charging the battery, wherein the micro gas turbine includes:
a compressor and a turbine, a rotor of the compressor and a rotor of the turbine being arranged on a common drive shaft, wherein the drive shaft is supported using at least two anti-friction bearings, of which one is arranged in a vicinity of the compressor rotor and one is arranged in a vicinity of the turbine rotor, wherein the drive shaft is of hollow design, and wherein an internal cavity of the drive shaft is filled with an evaporable cooling medium.

12. The motor vehicle as claimed in claim 11, wherein the internal cavity is of conical design in an axial direction of the drive shaft, and wherein a smaller diameter of the internal cavity lies in the vicinity of the compressor rotor and a larger diameter of the internal cavity lies in the vicinity of the turbine rotor.

13. The motor vehicle as claimed in claim 11, wherein a wall of the internal cavity of the drive shaft has radially inwardly projecting ribs.

14. The motor vehicle as claimed in claim 11, wherein the turbine rotor is of solid design and is fastened on an end of the drive shaft.

15. The motor vehicle as claimed in claim 11, wherein the compressor rotor has a bore through which the drive shaft extends.

16. The motor vehicle as claimed in claim 15, wherein a rotor of a generator is arranged on the drive shaft.

17. The motor vehicle as claimed in claim 16, wherein the turbine rotor lies on one side of the compressor rotor and the rotor of the generator lies on the other side of the compressor rotor.

18. The motor vehicle as claimed in claim 11, wherein flow passes radially through at least one of: the compressor rotor or the turbine rotor.

19. The motor vehicle as claimed in claim 11, further comprising:
a bearing shield arranged between the anti-friction bearings and at least one of: the turbine rotor or the compressor rotor.

20. The motor vehicle as claimed in claim 11, wherein the micro gas turbine has rated power of 30 kW or less.
